(19) United States
(12) Patent Application Publication
(10) Pub. No.: US 2006/0099998 A1
(43) Pub. Date: May 11, 2006

(54) System and method for measuring a power cutoff level in a mobile terminal

(75) Inventors: Hae-Sung Kang, Seoul (KR); Jae-Hyeok Lee, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/256,258

(22) Filed: Oct. 21, 2005

(30) Foreign Application Priority Data
Oct. 21, 2004 (KR) 84573/2004

(51) Int. Cl. H04B 1/16; H04B 1/38

(52) U.S. Cl. 455/572; 455/343.1

(57) ABSTRACT

A system and method are provided for measuring a power cutoff level in a mobile terminal. The system includes a power cutoff level measurer, a power supply, and a mobile terminal. The power cutoff level measurer sends a predetermined power supply command to the power supply. The power supply supplies the mobile terminal with a predetermined amount of power in response to the power supply command. The mobile terminal supplies its modules with the power to operate the modules, and sends operation information of the modules to the power cutoff level measurer. The power cutoff level measurer receives an operation signal from the mobile terminal, and determines a point in time at which the operation of the mobile terminal is stopped. The power cutoff level measurer measures a power cutoff level at the point in time at which the operation of the mobile terminal is stopped.

### PRIORITY

This application claims priority to an application entitled “SYSTEM AND METHOD FOR MEASURING A POWER CUTOFF LEVEL IN A MOBILE TERMINAL”, filed in the Korean Intellectual Property Office on Oct. 21, 2004 and assigned Serial No. 2004-84573, the entire contents of which are incorporated herein by reference.

### BACKGROUND OF THE INVENTION

1. Field of the Invention

The present invention relates generally to a power control system and method in mobile terminals including cellular phones, personal digital assistants (PDA), hand held phones (HHP), digital communication devices, etc., and more particularly to a system and method for measuring a power cutoff level in a mobile terminal.

2. Description of the Related Art

Conventionally, an analog wireless communication system is defined as the first-generation system, and a digital system for transmitting relative low speed data including voice in a wireless network is defined as the second-generation system. The second-generation wireless service has developed into the third-generation service, which provides a high-speed Internet or multimedia service based on wired and wireless convergence. It is a trend that the third-generation mobile communication referred to as the International Mobile Telecommunication (IMT)-2000 is developing into the fourth-generation mobile communication service to provide very high speed data transfer, large capacity, and provide for greater mobility of the mobile terminal.

With the development of the mobile communication services, mobile terminals that provide the mobile communication services are becoming compact and multifunctional. The mobile terminals may include a cellular phone, personal digital assistant (PDA), hand held phone (HHP), digital communication device, etc. In the near future, a product of a new concept will come onto the market with the acceleration of technology development and convergence. Accordingly, various functions such as a camera function, multimedia service function, touch screen function, etc. will be applied to the mobile terminal. To perform the various functions, various modules such as a camera module, display module, audio module, touch pad, etc. will be mounted in the mobile terminal. Function and performance of the modules operating in the mobile terminal are becoming highly advanced with the development of the mobile communication services, the supplementary services, and the development of technologies, etc.

As the functions and applications of the mobile terminals are gradually extended, a need for improved performance of a power supply, that is, a battery, operating the mobile terminal exists. The mobile terminal has a battery for supplying power. A large amount of research is being performed on batteries. The battery provided in the mobile terminal has been significantly advanced with the development of a compact secondary battery for easy charging and discharging. Efforts to maximize the efficiency of the battery power consumption are increasing. The mobile terminal manages power consumption via software as in a method for reducing unnecessary power consumption by cutting off power supplied to unused modules of the mobile terminal. The power consumption is managed in the mobile terminal such that the efficiency of battery power consumption can be improved.

An available time of a battery in the mobile terminal can be defined as a time period between a power ON state when battery power is fully charged in the mobile terminal and a power OFF state when battery power is completely consumed. The mobile terminal is powered off on the basis of a predetermined power cutoff level. When the power cutoff level is reached, the mobile terminal is powered off. The power cutoff level is associated with specific voltage or power, etc. supplied to the mobile terminal. In the conventional technology, the power cutoff level is not accurately measured.

For example, is one system the power cutoff level is set using the lowest voltage of all of the operating voltages of the modules mounted in the mobile terminal, or in another system an allowable lowest voltage or power level is set according to a value experimentally determined by a developer or manufacturer. Alternatively, the power cutoff level may be set using both the lowest voltage of all of the operating voltages of the modules mounted in the mobile terminal and the allowable lowest voltage or power level set according to a value experimentally determined by the developer or manufacturer. When the lowest voltage operates in the mobile terminal configured by the modules, a use voltage value according to the operating characteristics may be not accurately reflected. A value set by the developer or manufacturer may be not accurately measured. When the power cutoff level set by the above process is applied to the mobile terminal, an allowable power cutoff level might be set too high. Because spare voltage is set in the mobile terminal, the power cutoff level of the mobile terminal is not accurately measured. Accordingly, power supplied to the mobile terminal is not sufficiently utilized.

When the mobile terminal operates, its power consumption is not constant according to the system characteristics or the system operating states. This will be described with reference to FIG. 1.

FIG. 1 is a graph illustrating voltage characteristics according to an operating time of a mobile terminal.

Referring to FIG. 1, the graph illustrates voltage characteristics varying with the passage of time or operation of the mobile terminal. In the graph, the horizontal axis indicates time, and the vertical axis indicates voltage. Here, “A” denotes a theoretical characteristic curve. The mobile terminal does not operate according to the theoretical characteristic curve denoted by “A”. For example, when a global system for mobile communication (GSM) using time division multiple access (TDMA) transfers data in a predetermined data transfer interval, TDMA burst power is consumed. Accordingly, the mobile terminal in the GSM system has a characteristic curve denoted by “B”. Voltage drop occurs in a period of approximately 4.615 ms in the GSM system consuming the TDMA burst power. Accordingly, power is interrupted because of the voltage drop even though sufficient operating voltage remains in the mobile terminal. When the power cutoff level is not properly set, the mobile terminal may be abnormally powered off because of the voltage drop.

### SUMMARY OF THE INVENTION

The power cutoff level applied to the mobile terminal is set according to theoretical characteristics. However, there is a problem in that the power is interrupted even though sufficient voltage remains in the mobile terminal because an accurate power cutoff level cannot be set or measured according to the system characteristics. Moreover, there is another problem in that an available time of the mobile terminal is reduced because the power cutoff level of the mobile terminal cannot be accurately measured and thus the available time of the mobile terminal cannot be optimized.

Accordingly, the present invention has been designed to solve at least the above and other problems occurring in the prior art. Therefore, it is an aspect of the present invention to provide a system and a method that accurately measure a power cutoff level in a mobile terminal.

It is another aspect of the present invention to provide a system and a method that efficiently utilize power of a mobile terminal by accurately measuring a power cutoff level therein.

It is yet another aspect of the present invention to provide a system and method that optimize an available time of a mobile terminal by accurately measuring and applying a power cutoff level therein.

The above and other aspects of the present invention can be achieved by a method for measuring a power cutoff level in a mobile terminal. The method includes sending a predetermined power supply command from a power cutoff level measurer to a power supply; supplying a predetermined amount of power from the power supply to a mobile terminal in response to the power supply command; supplying modules of the mobile terminal with the power such that the mobile terminal operates the modules, and sending operation information of the modules to the power cutoff level measurer; receiving an operation signal from the mobile terminal, and determining in the power cutoff level measurer a point in time at which operation of the mobile terminal is stopped; and measuring a power cutoff level at the point in time at which the operation of the mobile terminal is stopped.

The above and other aspects of the present invention can be achieved by a system for measuring a power cutoff level in a mobile terminal. The system includes a power supply for receiving a power supply command signal and supplying-power according to the power supply command signal, a mobile terminal for receiving the predetermined power from the power supply, supplying modules of the mobile terminal with the received power to operate the modules, and sending operation information of the modules; and a power cutoff level measurer for sending the power supply command signal to the power supply, receiving the operation information from the mobile terminal, and measuring a power cutoff level at a point in time at which operation of the mobile terminal is stopped.

### BRIEF DESCRIPTION OF THE DRAWINGS

The above and other aspects and advantages of the present invention will be more clearly understood from the following detailed description taken in conjunction with the accompanying drawings, in which:

FIG. 1 is a graph illustrating voltage characteristics according to operation time of a conventional mobile terminal;

FIG. 2 is a block diagram illustrating a mobile terminal in accordance with an embodiment of the present invention;

FIG. 3 is a block diagram illustrating a system for measuring a power cutoff level in the mobile terminal in accordance with an embodiment of the present invention;

FIG. 4 is a signal flow diagram illustrating a process for measuring the power cutoff level in the mobile terminal in accordance with an embodiment of the present invention;

FIG. 5 is a flow chart illustrating operation of a power cutoff level measurer for measuring the power cutoff level in the mobile terminal in accordance with an embodiment of the present invention;

FIG. 6 is a flow chart illustrating operation of the mobile terminal when the power cutoff level is measured in accordance with an embodiment of the present invention; and

FIG. 7 is a flow chart illustrating operation of a power supply when the power cutoff level is measured in accordance with an embodiment of the present invention.

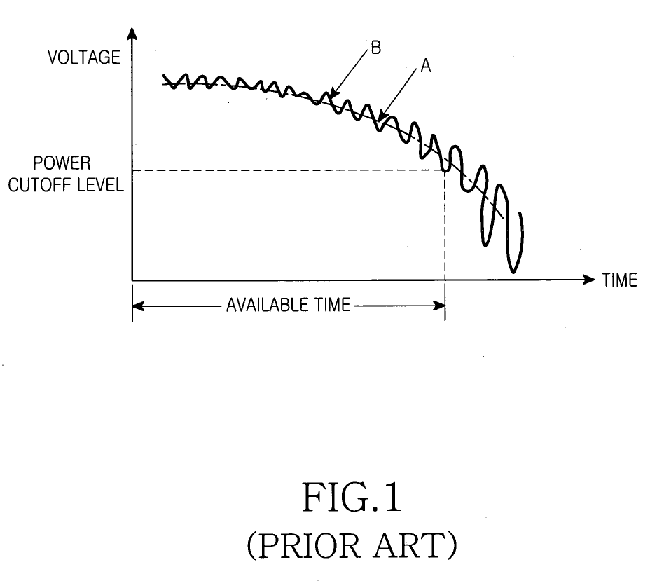

### DETAILED DESCRIPTION OF THE PREFERRED EMBODIMENTS

Preferred embodiments of the present invention will be described in detail herein below with reference to the accompanying drawings. In the following description, a detailed description of known functions and configurations incorporated herein will be omitted for conciseness.

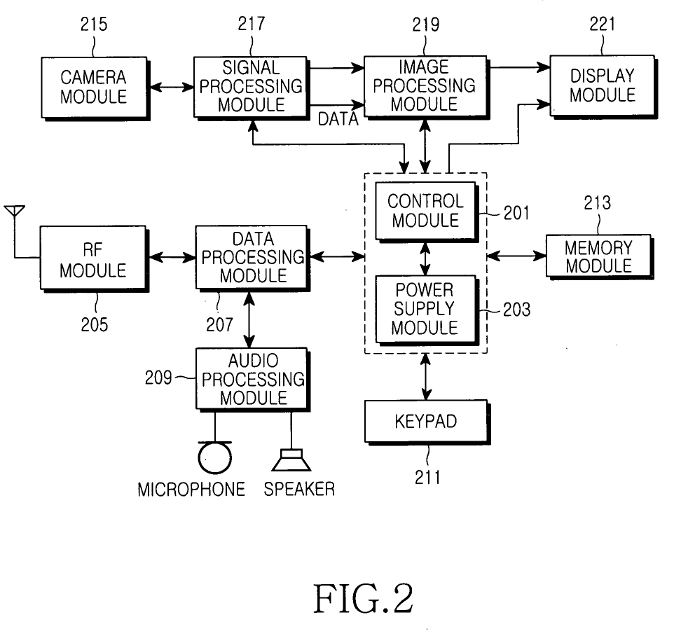

FIG. 2 is a block diagram illustrating a mobile terminal in accordance with an embodiment of the present invention.

Referring to FIG. 2, a radio frequency (RF) module 205 controls the wireless communication of the mobile terminal. The RF module 205 includes an RF transmitter for up converting and amplifying a frequency of a signal to be transmitted and an RF receiver for low-noise amplifying a received signal and down converting a frequency of the received signal.

A data processing module 207 includes a transmitter for coding and modulating the signal to be transmitted and a receiver for demodulating and decoding the received signal. That is, the data processing module 207 can be composed of a modulator-demodulator (MODEM) and a coder-decoder (CODEC).

An audio processing module 209 reproduces a received audio signal output from the data processing module 207 or outputs a transmission audio signal generated from a microphone to the data processing module 207.

A keypad 211 includes keys necessary for inputting number and letter information and function keys necessary for setting various functions.

A memory module 213 can be composed of program and data memories, etc. The program memory can store programs for controlling the overall operation of the mobile terminal. The data memory temporarily stores data generated while the programs are executed.

A control module 201 controls the overall operation of the mobile terminal. The control module 201 may include the data processing module 207. The control module 201 controls the modules of the mobile terminal in accordance with the present invention. The control module 201 controls a power supply module 203 to supply power necessary to operate each module. The control module 201 exchanges, with a power cutoff level measurer outside the mobile terminal, control information according to operation of each module.

When the mobile terminal operates, the power supply module 203 supplies voltage or power for operating each module inside the mobile terminal using a battery or external power supply according to a control operation of the control module 201.

A camera module 215 captures an image, and a signal processing module 217 processes an image signal output from the camera module 215. An image processing module 219 generates display data to display the image signal output from the signal processing module 217. The image processing module 219 outputs the image signal or data received under control of the control module 201 according to the format of a display module 221.

Operation of the mobile terminal will be described with reference to FIG. 2. In the mobile terminal, the above-mentioned modules operate according to a control operation of the control module 201. Power must be supplied to the modules such that they can operate. The control module 201 controls the power supply module 203 to supply the mobile terminal with power according to operating mode of each module.

Here, the power supply module 203 receives power from a power supply outside of the mobile terminal, and supplies the received power in a corresponding operating mode of the mobile terminal according to a control operation of the control module 201. The power supply module 203 can receive power applied from the external power supply or can use a battery capable of being attached to and detached from the mobile terminal.

The control module 201 provides the power cutoff level measurer outside of the mobile terminal with the operation information for each module operating in the mobile terminal. The mobile terminal can receive a control signal from the power cutoff level measurer to control its modules. The present invention is not limited to mobile terminals.

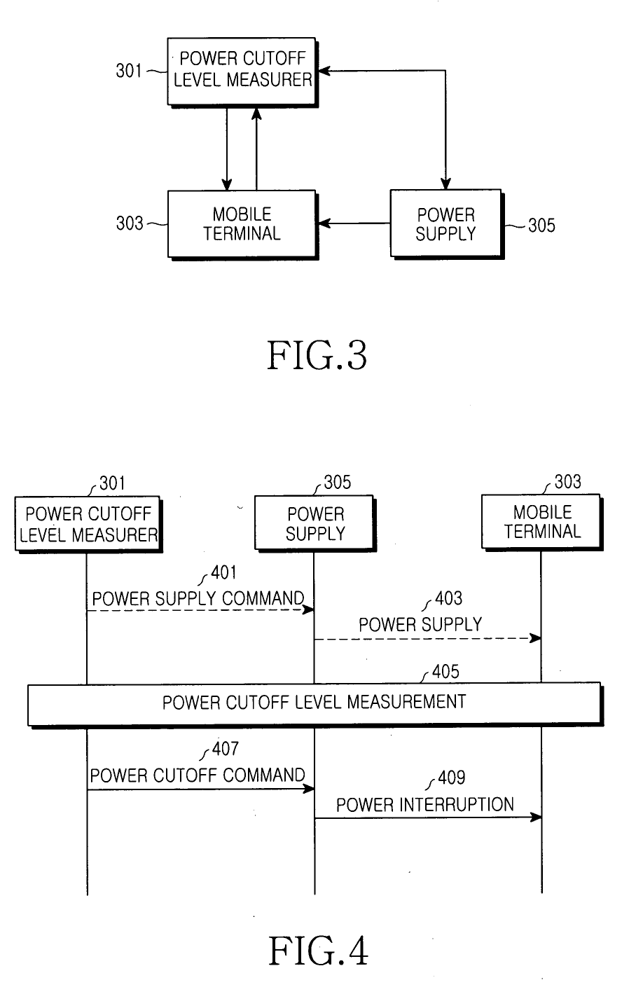

A system for measuring a power cutoff level in the mobile terminal will be described with reference to FIGS. 3 and 4.

FIG. 3 is a block diagram illustrating a system for measuring a power cutoff level in the mobile terminal in accordance with an embodiment of the present invention, and FIG. 4 is a signal flow diagram illustrating a process for measuring the power cutoff level in the mobile terminal in accordance with an embodiment of the present invention.

Referring to FIGS. 3 and 4, the system for measuring the power cutoff level in a mobile terminal 303 includes a power cutoff level measurer 301, the mobile terminal 303, and a power supply 305.

To measure the power cutoff level of the mobile terminal 303, the power cutoff level measurer 301 sets a predetermined power or voltage value, and sends a predetermined power supply command signal to the power supply 305 (Step 401).

The power supply 305 receiving the power supply command signal supplies power to the mobile terminal 303 according to the power or voltage value set by the power cutoff level measurer 301 (Step 403).

When the power is supplied from the power supply 305 to the mobile terminal 303, each module of the mobile terminal 303 operates in a corresponding operating mode. The mobile terminal 303 sends information associated with an operating state, that is, operation information, to the power cutoff level measurer 301. The power cutoff level measurer 301 receives the information from the mobile terminal 303, sets the next power value for performing the next power supply command, and provides the set power value to the power supply 305. The mobile terminal 303 sends operation information of each module of the mobile terminal 303 associated with the changed power. The above-mentioned process is continuously repeated until the operation of the mobile terminal 303 is stopped.

When the operation of the mobile terminal 303 is stopped, the mobile terminal 303 no longer sends operation information to the power cutoff level measurer 301. At this time, the power cutoff level measurer 301 sets a power cutoff level to be applied to the mobile terminal 303 by measuring the power supplied thereto (Step 405).

Subsequently, the power cutoff level measurer 301 sends a power cutoff command to the power supply 305 (Step 407). The power supply 305 receiving the power cutoff command interrupts power being supplied to the mobile terminal 303 (Step 409).

The power cutoff level measurer 301 can use various methods for measuring a power cutoff level in the mobile terminal 303. For example, the power cutoff level measurer 301 can measure the power cutoff level by measuring a power value at a point in time at which the operation of the mobile terminal 303 is stopped while the power of the mobile terminal 303 is changed from a high level value to a low level value.

The power cutoff level measurer 301 may also receive an operation signal from the mobile terminal 303 to measure its operating state. The operation signal is information that indicates if the mobile terminal 303 is normally operating. The power cutoff level measurer 301 can measure the power cutoff level using only the information serving as the operation signal. In this case, the information of the operating state is exchanged between the power cutoff level measurer 301 and the mobile terminal 303. A method for transmitting and receiving additional operation information as well as the information of the operating state may be applied. In this case, the power cutoff level measurer 301 can measure the power cutoff level by making use of an increased amount of operation information.

The power cutoff level measurer 301 may also send, to the mobile terminal 303, control information necessary to operate each module and receive operation information when power is supplied according to the operation of some of the modules. For example, to find a power cutoff level in the modules performing a call function, the power cutoff level measurer 301 sends control information associated with only the modules performing the call function, and supplies power through the power supply 305. Through the above-mentioned process, the power cutoff level measurer 301 measures a power cutoff level according to the operation of some of the modules. When the power cutoff level measurer 301 measures a power cutoff level according to the operation of some of the modules performing the call function and the measured power cutoff level is applied to the mobile terminal 303, the available time of the mobile terminal 303 can be extended.

The present invention can accurately find an available time of the mobile terminal 303 when measuring the power cutoff level in the mobile terminal 303 through the above-mentioned process as compared with the prior art. A more accurate power cutoff operation can be performed for the mobile terminal 303. The power cutoff level measurer 301, the mobile terminal 303, and the power supply 305 in the system for measuring the power cutoff level in the mobile terminal 303 will be described with reference to the accompanying drawings.

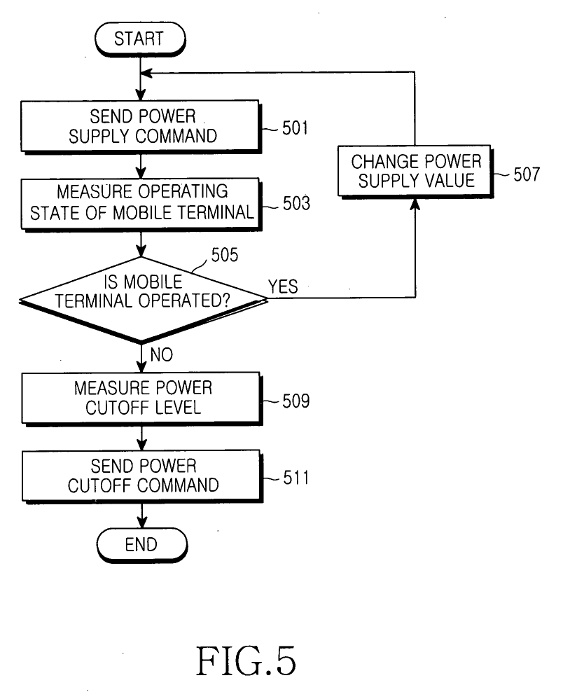

FIG. 5 is a flow chart illustrating operation of the power cutoff level measurer for measuring the power cutoff level in the mobile terminal in accordance with an embodiment of the present invention.

Referring to FIG. 5, the power cutoff level measurer sends a power supply command to the power supply such that the power supply can supply the mobile terminal with power (Step 501). At this time, the power cutoff level measurer sets a value of power to be supplied to the mobile terminal and sends the set power value to the power supply. Then, the power cutoff level measurer receives the operation information of the mobile terminal and measures an operating state of the mobile terminal (Step 503). The power cutoff level measurer measures the operating state of the mobile terminal while receiving the operation information. When the mobile terminal does not operate, no operation information is received. Accordingly, the power cutoff level measurer determines if the mobile terminal operates (Step 505). At this time, if the mobile terminal operates, the power cutoff level measurer changes a value of power to be supplied to the mobile terminal. The power cutoff level measurer sends the next power supply command based on the changed power value to the power supply (Step 507). However, if the mobile terminal does not operate, the power cutoff level measurer measures a power cutoff level using a value of supplied power at a point in time at which the operation of the mobile terminal is stopped (Step 509). After the power cutoff level is set, the power cutoff level measurer sends a power supply cutoff command to command the power supply to interrupt power supply to the mobile terminal (Step 511).

The power cutoff level set by the power cutoff level measurer is provided to the mobile terminal such that the set power cutoff level is later applied.

The power cutoff level measurer can perform the above-mentioned function by making use of a general computer, etc., and can be specially manufactured to measure the power cutoff level.

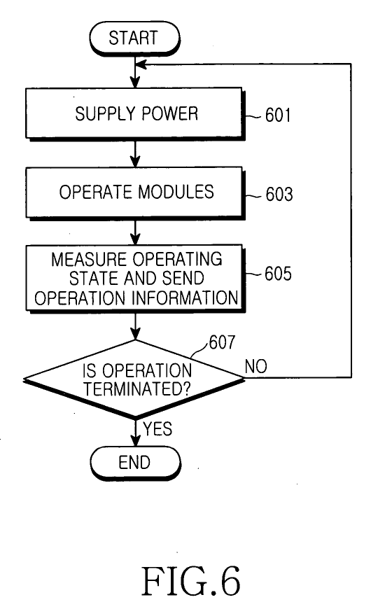

FIG. 6 is a flow chart illustrating operation of the mobile terminal when the power cutoff level is measured in accordance with an embodiment of the present invention.

Referring to FIG. 6, the mobile terminal receives power from the power supply (Step 601). The mobile terminal operates its modules by supplying power thereto (Step 603). When the modules operate, the mobile terminal measures an operating state and sends the operation information of the modules such that operating states of the modules can be identified (Step 605). A method for measuring an operating state will be described below. Subsequently, a determination is made as to whether the mobile terminal operates (Step 607). If a value of power supplied to the mobile terminal is a value of power sufficient to operate the mobile terminal, the mobile terminal operates normally. The mobile terminal then receives changed power. However, if operation of the mobile terminal is terminated, it does not send the operation information to the power cutoff level measurer.

According to a method for measuring operation information using the mobile terminal, the maximum consumption power is set by consumption power at the time of operating the modules of the mobile terminal and the operation information is identified before power is interrupted. The identified operation information is a value based on the maximum consumption power. When the mobile terminal consumes the maximum power, the operating voltage can be measured. A power cutoff level is measured on the basis of the maximum power consumption, and the measured level is applied to the mobile terminal. The power cutoff level can be set in the mobile terminal by taking into account the maximum power being consumed. Because the power cutoff level of the maximum power consumption is measured while the mobile terminal operates, an abnormal power off operation of the mobile terminal can be avoided, but a stable power off operation can be performed.

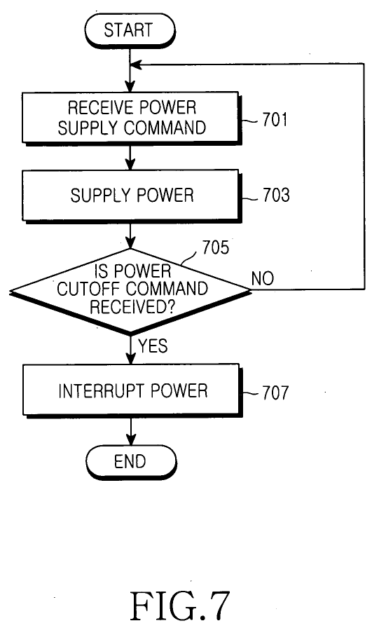

FIG. 7 is a flow chart illustrating operation of the power supply when the power cutoff level is measured in accordance with an embodiment of the present invention.

Referring to FIG. 7, the power supply receives a power supply command from the power cutoff level measurer (Step 701). After receiving the power supply command, the power supply supplies the mobile terminal with power (Step 703). Subsequently, the power supply determines if a power cutoff command is received (Step 705). If no power cutoff command is received, the next power supply command is received from the power cutoff level measurer. However, if the power cutoff command is received from the power cutoff level measurer, power supply to the mobile terminal is interrupted.

The power supply can set the power voltage to be applied to the mobile terminal without receiving a power supply command from the power cutoff level measurer. In this case, the power cutoff level measurer can measure a power cutoff level using the information of the power applied from the power supply without setting a power supply value.

The power cutoff level measurer may include the power supply. Moreover, the power cutoff level measurer may measure a power cutoff level using a battery pack. The present invention is not limited to the power supply illustrated in FIG. 7.

When a power cutoff level in a mobile terminal is measured by the above-mentioned method and the measured power cutoff level is applied to the mobile terminal, the power of the mobile terminal can be interrupted at an accurate point in time. Using a method for measuring the power cutoff level in accordance with the present invention, an available time of the mobile terminal can be accurately measured and optimized.

Although preferred embodiments of the present invention have been disclosed for illustrative purposes, those skilled in the art will appreciate that various modifications, additions and substitutions are possible, without departing from the scope of the present invention. Therefore, the present invention is not limited to the above-described embodiments, but is defined by the following claims, along with their full scope of equivalents.

What is claimed is:

1. A system for measuring a power cutoff level in a mobile terminal, comprising:
a power supply for receiving a power supply command signal and supplying power according to the power supply command signal;
a mobile terminal for receiving the predetermined power from the power supply, supplying modules of the mobile terminal with the received power to operate the modules, and sending operation information of the modules; and
a power cutoff level measurer for sending the power supply command signal to the power supply, receiving the operation information from the mobile terminal, and measuring a power cutoff level at a point in time at which operation of the mobile terminal is stopped.

2. The system according to claim 1, wherein the power cutoff level uses one of a voltage and power value.

3. The system according to claim 1, wherein the mobile terminal comprises:
a control module for controlling an operation for supplying the modules of the mobile terminal with the power, and providing the power cutoff level measurer with the operation information of the modules; and
a power supply module for receiving the power from the power supply, and supplying the modules of the mobile terminal with the power according to a control operation of the control module.

4. The system according to claim 1, wherein the power cutoff level measurer changes a power supply value until the operation of the mobile terminal is stopped, and sends the power supply command signal.

5. The system according to claim 1, wherein operation of the power cutoff level measurer is performed by a computer.

6. The system according to claim 1, wherein the power supply directly supplies the mobile terminal with the power, and sends information of the supplied power to the power cutoff level measurer.

7. The system according to claim 1, wherein the power supply is one of included in the power cutoff level measurer, and a battery of the mobile terminal.

8. The system according to claim 1, wherein the measuring of the power cutoff level determines a maximum consumption power of the modules of the mobile terminal.

9. The system according to claim 8, wherein when less than all of the modules of the mobile terminal operate, the power cutoff level is remeasured.

10. The system according to claim 1, wherein the power cutoff level measurer transmits and receives operation information of the mobile terminal.

11. The system according to claim 1, wherein the mobile terminal interrupts the power based on the power cutoff level.

12. A method for measuring a power cutoff level in a mobile terminal, comprising the steps of:
sending a predetermined power supply command from a power cutoff level measurer to a power supply;
supplying a predetermined amount of power from the power supply to a mobile terminal in response to the power supply command;
supplying modules of the mobile terminal with the power such that the mobile terminal operates the modules, and sending operation information of the modules to the power cutoff level measurer;
receiving in the power cutoff level measurer an operation signal from the mobile terminal, and determining a point in time at which the operation of the mobile terminal is stopped; and
measuring a power cutoff level at the point in time at which the operation of the mobile terminal is stopped.

13. The method according to claim 12, wherein the power cutoff level uses one of a voltage and power value.

14. The method according to claim 12, wherein the power cutoff level measurer changes a power supply value until the operation of the mobile terminal is stopped, and sends the power supply command.

15. The method according to claim 12, wherein supplying the predetermined amount of power from the power supply to the mobile terminal comprises the step of:
supplying the mobile terminal with the power, and sending information of the supplied power to the power cutoff level measurer.

16. The method according to claim 12, wherein measuring the power cutoff level comprises the step of:
measuring the power cutoff level to obtain a maximum consumption power of the modules of the mobile terminal.

17. The method according to claim 16, wherein when less than all of the modules of the mobile terminal operate, the power cutoff level is remeasured.

18. The method according to claim 12, further comprising the step of:
exchanging predetermined operation information between the power cutoff level measurer and the mobile terminal.
